(19) United States
(12) Patent Application Publication
(10) Pub. No.: US 2012/0214706 A1
(43) Pub. Date: Aug. 23, 2012

(54) RAPID DETECTION OF SNP CLUSTERS

(76) Inventor: Marc Zabeau, Gent (BE)

(21) Appl. No.: 13/499,726

(22) PCT Filed: Oct. 5, 2010
(86) PCT No.: PCT/EP2010/064811

§ 371 Date: May 2, 2012

(30) Foreign Application Priority Data
Oct. 6, 2009 (EP) 09172286.8

(51) Int. Cl. C40B 30/04

(52) U.S. Cl. 506/9

(57) ABSTRACT

The present invention relates to the rapid detection of clusters of single nucleotide polymorphisms (SNPs) using an array technology. It further relates to the use of these clusters as markers in strain improvement and breeding, and in strain identification.

The present invention relates to the rapid detection of clusters of single nucleotide polymorphisms (SNPs) using an array technology. It further relates to the use of these clusters as markers in strain improvement and breeding, and in strain identification.

DNA sequence polymorphism among microbial strains or individual species plays an essential role in the determination of phenotypical differences. Polymorphisms can be linked to positive or negative characteristics, and are therefore extremely helpful, as a non limiting example, in diagnosis of genetic diseases, but also in the breeding of crops, animals and industrial microorganisms.

Large scale polymorphism overviews have been published for Arabidopsis thaliana, for mouse and for human. Moreover, recent genomic analysis and mass sequence allowed the genomic comparison of several Saccharomyces cerevisiae and Saccharomyces paradoxus strains (Schacherer er al., 2007; Schacherer et al., 2009; Liti et al., 2009). From these data, it became obvious that there is a huge genomic variation between closely related organisms, and that polymorphism can be used to study population dynamics. Moreover, those data were showing that apart from large deletions, smaller indels and SNPs occur at high frequency, and SNPs show a tendency to cluster in regions with indels (Tian et al, 2008).

Due to their frequency, which is higher than the frequency of indels, SNP clusters have an interesting potential to serve as natural markers for strain identification and strain breeding. Indeed, for the latter case, SNP clusters are quite equally distributed over the whole genome, and can be linked to essential characteristics of a certain strain, allowing rapid identification op potential interesting descendant in breeding experiments. However, one of the drawbacks is the rapid identification of SNP clusters. Indeed, a lot of attention was paid to the identification of large indels, and of individual SNPs, but the identification of short indels (in the range up to 20) and SNP clusters have not been studied to the same extent. This is largely due to the fact that techniques for identification of large indels at one hand, and individual SNPs at the other hand are not suitable for detection of short indels or SNP clusters.

Tiling arrays have been developed to detect genome wide polymorphisms at nucleotide resolution (Gresham et al., 2006). However, due to the specific design of those microarrays, with the use of short oligonucleotides, the system is not suitable for the detection of SNP clusters or indels, as the ratio matches on mismatches is decreasing the more SNP are present in the cluster, or the larger the indel.

Surprisingly we found that designing an array with several larger oligonucleotides for one target sequence, whereby those oligonucleotides differ in hybridization efficiency allows to detect SNP clusters, as well as short indels in a reliable manner. A short indel, as used here is an indel from 3 nucleotides up to 15 nucleotides. Oligonucleotides, used for the microarray, can be designed by comparing the genomes of two strains of a certain micro-organism or organism, or, where applicable, the genome of at least two individuals for non-clonal organisms, and identifying SNP clusters, possibly in combination with short indels. Especially, SNP clusters are interesting, as the frequency of SNP clusters is far higher than that of small indels, and therefore, the SNP clusters can be used as markers with high resolving capacity. However, till now, a method for analysis of SNP clusters using a microarray method has not been described, and the method of the invention is the first reliable microarray method for the detection of SNP clusters.

A first aspect of the invention is a method for detecting at least one target sequence comprising a cluster of at least two single nucleotide polymorphisms (SNPs), said method comprising hybridizing the target sequence against an array of a set of at least 2 oligonucleotides, preferably at least 3-oligonucleotides, more preferably at least 4 oligonucleotides, more preferably at least 5 oligonucleotides, even more preferably more than 10 oligonucleotides, most preferably more than 15 oligonucleotides whereby said set of oligonucleotides consist of a variations in sequence of the complement of the target sequence with a different hybrization efficiency. Preferably, said oligonucleotides are at least 30 nucleotides long, even more preferably at least 40 nucleotides long. One set of oligonucleotides as described here is directed against one target sequence. A SNP as used here means that there is a difference in nucleotide sequence of one single nucleotide, when two or more sequences of different strains or individuals of the same or related species are compared. A cluster of SNPs, as used here, means that at least two SNPs, preferably 0.3 or more SNPs occur closely to each other, preferably separated by less than 10 nucleotides, even more preferably separated by less than 5 nucleotides, more preferably less than 4 nucleotides, even more preferably less than 3 nucleotides, most preferably less than 2 nucleotides. When there are more than two SNPs, the distance between the individual SNPs in the cluster may differ. Differences in hybridization efficiency may be obtained in several ways. As a non limiting example, for a known SNP cluster determined by comparing sequence A and B, one can use oligonucleotides with an increasing number of mismatches, going from a perfect match for one sequence A, to a perfect match for the other sequence B. Alternatively, mismatches may be introduced upstream and downstream of the SNP cluster, possible in combination with the matching or mismatching SNPs (‘mismatch hybridization’). In a preferred embodiment, said mismatches are situated in a region from 8 to 13 nucleotides both from the 5′ en 3′ end. Preferably, there is one upstream and one downstream mismatch; even more preferably, several oligonucleotides, preferably more than 6, even more preferably 10 or more are designed with different combinations of mismatches in those regions. In still another embodiment, the ‘sliding window hybridization’ may be used. In this case, a set of oligonucleotides is used of similar, preferably identical length in which the cluster is situated between two flanking sequences identical to the natural occurring flanking genomic DNA sequences, but whereby the length of upstream and downstream flanking sequences are varying. Sliding window hybridization probes may be combined with mismatch hybridization probes, to increase the sensitivity of the array. In another preferred embodiment, the differences in hybridization are obtained by using primers with a modified DNA structure, such as primers with chemically modified bases, or primers with a modification in the backbone, such as LNA. The use of clusters of SNPs in the design of a microarray, as described in this invention, have the advantage to result in a better signal to noise ratio, and a better resolution, allowing a clear identification of the fragments used in the microarray experiment. The microarray may be designed to detect only SNP clusters, or alternatively, it may be designed to detect SNP clusters together with small indels.

Another aspect of the invention is the use of the method according to the invention for strain identification. Indeed, as the design of the oligonucleotides in one set on the array is based on the comparison of at least two divergent genomes on one species (or two related species), whereby in the same set of varying oligonucleotides some are optimized for the hybridization with the target derived from the first genome, whereas others are optimized to hybridize with the target derived from another genome, the hybridization efficiency for every single oligonucleotide will be strain dependent. In a preferred embodiment, two genomes are used whereby the oligonucleotides within one set vary between maximal hybridization capacity with the target of the first genome towards maximal hybridization capacity with the related target sequence of the second genome. From this design, it is clear that the hybridization pattern on the array will differ for both parental strains; however, even when nucleic from not related strains is used for hybridization against the array, there will be a preferential hybridization for one or more oligonucleotides of one set, resulting in a specific pattern for the strain that can be used for fingerprinting of said strain. A preferred embodiment of the invention is the use of the method according to the invention for yeast identification and/or characterization of a yeast strain. Preferably, said yeast strain is a Saccharomyces species, even more preferably, said yeast is Saccharomyces cerevisiae.

It is clear that, when the array is designed on the base of two strains, as described above, such an array can be used to study the genomic composition of the crossing and offspring of the parental strains. Indeed, in every set of oligonucleotides on the array, there are oligonucleotides with a preferential hybridization for the first parental and other oligonucleotides for the second parental. This allows deducing, for every target sequence, whether it is derived from the first or the second parental. Moreover, recombinations or mutations in the target sequence, resulting in a hybridization pattern that differs from both parentals, can also be detected. Therefore, as SNP clusters and indels can be linked to phenotypical characteristics of the parentals, as described below. In this case, the offspring can be screened for the combination of relevant markers from both parental strains. In a setting where sporulation products are compared with the parental strains, preferably each spore is compared with both parentals, and two hybridizations with different labeling of parental strain and spore are used for each parental, resulting in 4 hybridizations per sporulation product analysis. By using this method, one can easily use a “universal” array, designed on the genetic diversity of a large group of yeast strains, instead of an array with oligonucleotides based on the sequence differences of the parental strains.

Therefore, still another aspect of, the invention is the use of the method according to the invention for the identification and/or of genetic markers, linked to a phenotype useful for breeding. A phenotype useful for breeding means that it is a phenotype that one wants to incorporate or to avoid in the offspring of a breeding experiment. As a non-limiting example, such phenotype can be an increase of yield, an increase of stress resistance or an improved resistance against chemicals, such as increase resistance against ethanol for yeast. Preferably, said phenotype is a multigenic phenotype, i.e. that it is determined by more than one gene, preferably more than two genes, preferably more than three genes, preferably more than four genes, even more preferably more than five genes. For marker selection, mixture of at least two strains, preferably at least 20 strains, preferably at least 50 strains, preferably a complex mixture of more than on 100 strains is subjected to selective pressure, in a continuous or a discontinuous way. Samples are taken for array analysis at time 0, and after certain time intervals (for continuous selection), or after certain selection steps (for discontinuous selection). A shift in array pattern can be seen, with an enrichment of those markers that are linked to the phenotype for which is selected. The advantage of the method is that the markers can be identified on a mixed population, without the need to isolate individual strains for genomic analysis. Therefore, a preferred embodiment is the use of the method according to the invention for the identification of genetic marker, linked to a phenotype useful for breeding, whereby the identification of the marker is carried out on a sample of nucleic acid, preferably DNA, coming from a mixed population of strains.

Another preferred embodiment of the invention is the use of the method for the identification and/or detection of markers according to the invention for yeast characterization and/or yeast breeding. Preferably, said yeast is a Saccharomyces species, even more preferably, said yeast is Saccharomyces cerevisiae.

### BRIEF DESCRIPTION OF THE FIGURES

FIG. 1: By4742 (Cy5-labeled) versus sigma 1278 (Cy3-labeled)

FIG. 2: By4742 (Cy5-labeled) versus spore B1 (Cy3-labeled)

FIG. 3: By4742 (Cy5-labeled) versus spore A3 (Cy3-labeled)

FIG. 4: Sigma 1278 (Cy5-labeled) versus spore A4 (Cy3-labeled)

FIG. 5: Overview of the ratio of hybridization intensities for all markers after 3, 6, 9 and 10 heat shock cycles, over the initial value before heat shock (indicated as 0/3, 0/6, 0/9 and 0/10 respectively).

### RESULTS

### Example 1

### Probe Design

Two yeast strains, YJM981 and Y12 were selected on the base of their presumed sequence divergence, and the sequences were compared. Insertions, deletions and SNP clusters were identified, and on the base of those indels and SNP clusters, probes were designed. For every marker (be it an insertion, deletion or SNP cluster) tiling probes as well as mismatch probes were designed. For tiling probes, 11 probes for each allele were designed (going from 20 matching nucleotides 5′/10 matching nucleotides 3′ to 10 matching nucleotides 5′/20 matching nucleotides 3′. For mismatch probes, one complementary and 9 mismatch probes were designed; those 9 mismatches were combinations of three upstream and three downstream mismatches, whereby said mismatches were situated in the region 8-13 nucleotides from the 5′ or 3′ end. Probes were normally 40 nucleotides in length, except for large inserts (>15 nucleotides). The insertion and deletion probes were used as internal control.

### Example 2

### Use of Arrays for Strain Characterization

Probes were spotted on Agilent arrays according the procedure of the manufacturer. For the detection of the indels and snp clusters the DNA is extracted and labeled. Yeast, genomic DNA is isolated using the Lyticase method. 10 μg of genomic DNA is digested for 3 h with: Hind III+Bgl II+Xba I or Sac II+Mfe I+Dra I (1 unit of each enzyme/μg DNA). The digested genomic DNA is purified by precipitation with EtOH. Two μg of the purified DNA is labeled using for instance the protocol developed for microarray based comparative genomic hybridization by the Stanford Medical Center. For this purpose H₂O is added to 2 μg of DNA to obtain a total volume of 20 μl. Subsequently, 20 μl of 2.5× random primer solution is added and the mixture heated for 5 min at 95° C., after which it is put on ice. Subsequently, the following solutions are added: 5 μl dNTP mix (1.2 mM dAG-TTP+0.4 mM dCTP), 4 μl Cy3- or Cy5-dCTP mMyand 1 μl Klenow fragment. The mixture is incubated for 3 h at 37° C. after which 5 μl of stop buffer is added (from the Bio Prime DNA labeling kit, 0.5M Na₂EDTA, pH 8.0). The Cy3- or Cy5-labeled DNA is then purified using a QIAquick PCR purification kit. The CyDyes are obtained from Amersham Biosciences and the Bio Prime DNA labeling system from Invitrogen.

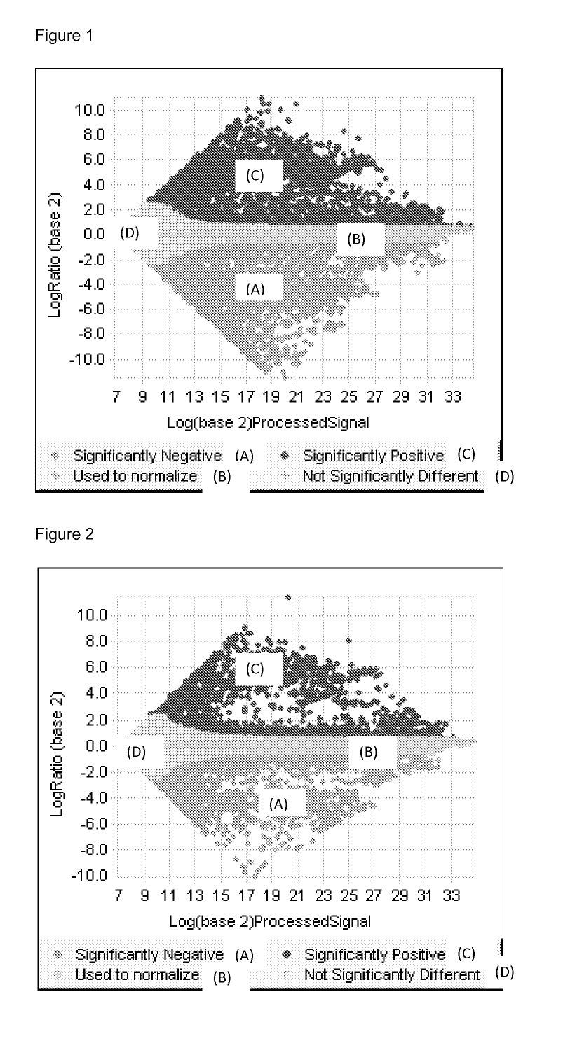

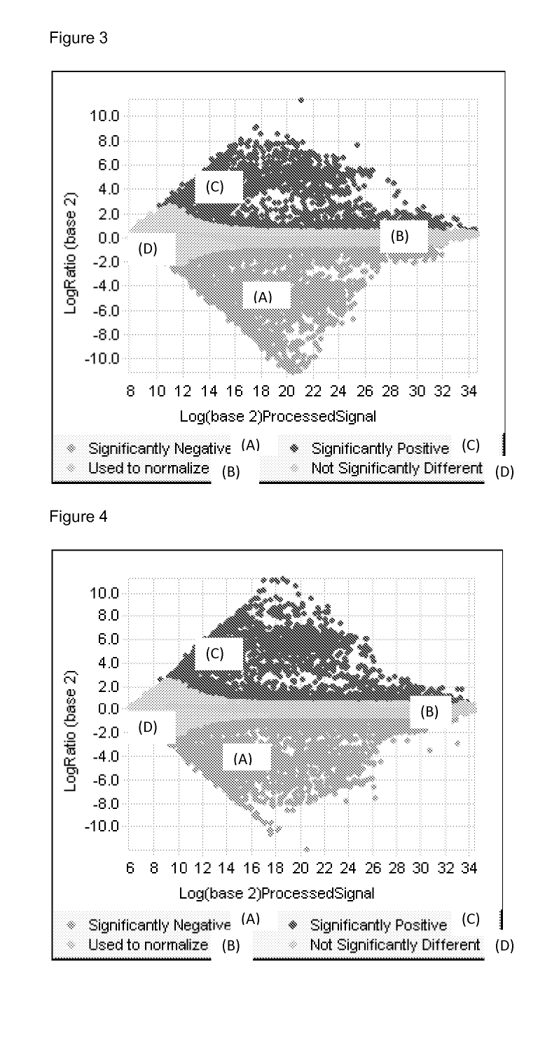

For convenient detection of the markers, DNA from one parental (BY4742) is labeled with Cy5-dCTP and DNA from the other parental (Sigma 1278) with Cy3-dCTP. To increase the sensitivity, also the mirror hybridization is carried out, whereby DNA from parental (Sigma 1278) is labeled with Cy5-dCTP and DNA from the other parental (BY4742) with Cy3-dCTP. To test the markers in the descendants, DNA of one of the parental strains (either the Cy3-dCTP or the Cy5-dCTP labeled) is replaced by DNA of a sporulation product. The sensitivity can even be increased when the DNA of the sporulation product is once compared with the first parental, and once with the second: every spore is tested against the two parental strains, whereby for each setting, two hybridizations with different labels are carried out (as an example: BY4742-Cy5 vs B1-Cy3; B1-Cy5 vs BY4742-Cy3; Sigma 1278-Cy5 vs B1-Cy3; B&-Cy5 vs Sigma 1278-Cy3). Clones derived from three spores have been compared, and notwithstanding the close relation between the strains, there is a clear distinction in microarray results (FIG. 1-4). Moreover, several markers can be identified as coming from BY4742 or from Sigma 1278 (Table 1).

### Example 3

### Use of the Array in Marker Selection

As the resolving capacity of the microarray is rather high, allowing to see shifts from one sequence to another, even in a complex background, an experiment was set up to detect which SNPs are enriched, when a pool of strains is subjected to stress, thereby selecting for those strains that more adapted to the stress. The SNPs that are enriched can be considered as useful resistance markers to the stress applied.

BY4742 α (Leu⁻, Trp⁺) was crossed with Sigma 1278 a (Leu⁺, Trp⁻), and diploids were selected by complementation of the markers. Diploids were transferred to a sporulation medium and sporulated for 5 days at room temperature. Spores were isolated, and a factor was used to obtain haploid a strains. The purified a strains (144) were pooled and subjected to heat stress. Therefore, the strain pool was grown in 50 ml YPD till OD=2, and a sample of 25 ml of the mixed culture was mixed with 25 ml preheated YPD (72° C.) and the mixture was kept for 30 minutes at 52° C. After the heat shock, 0.1 OD of treated cells was transferred to fresh medium, and grown at 30° C. When the density reached an OD=2 again, cells were subjected to the next heat shock. 10 cycles of heat shock were given, and after each cycle a sample was kept for analysis. From the start sample and the 10 heat shock samples, DNA was prepared and used for micro-array analysis.

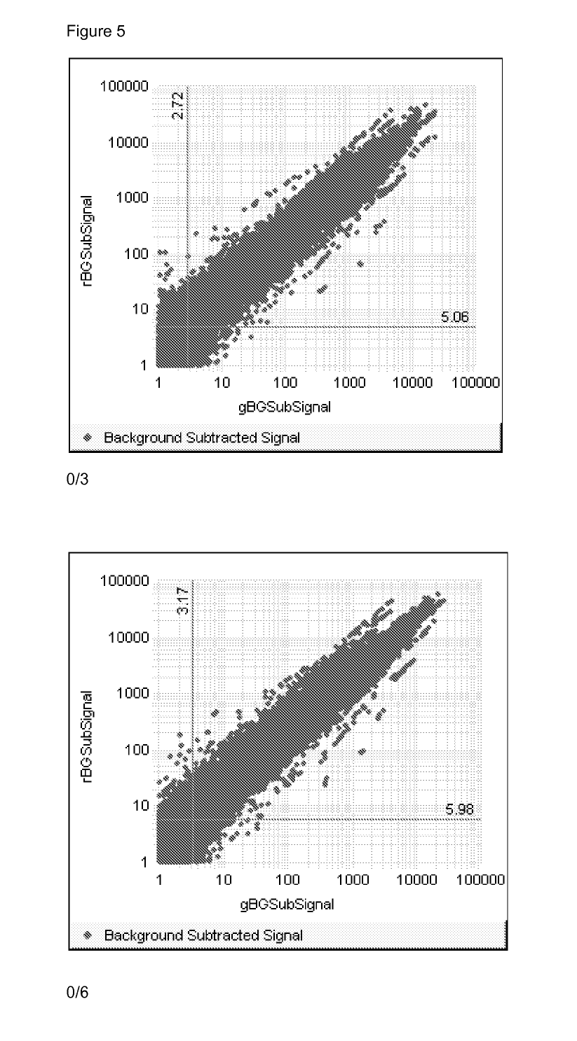

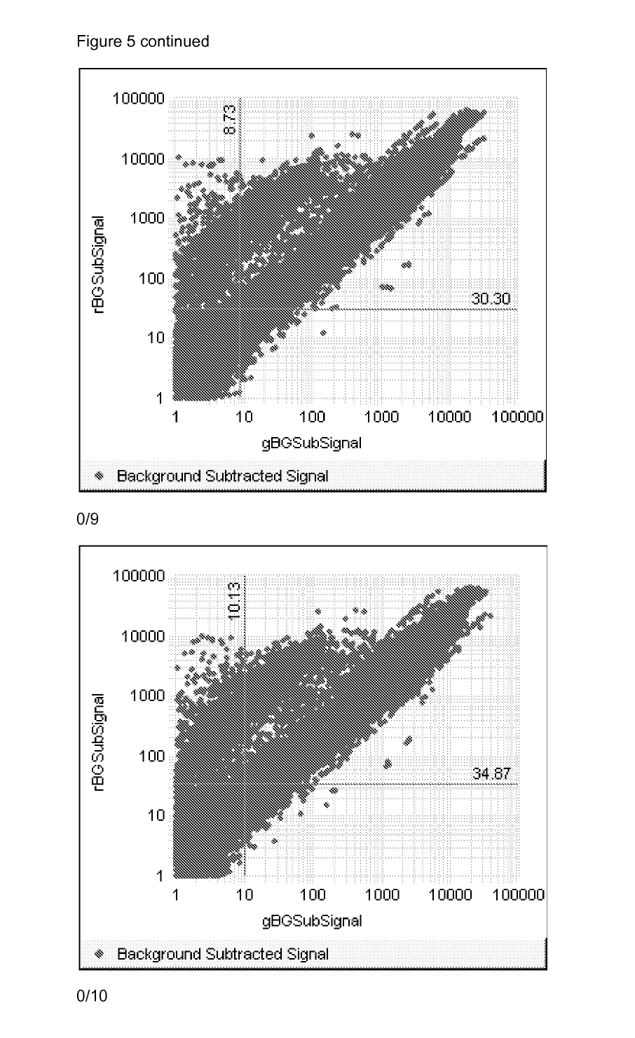

Micro array analysis was carried out as in example 2. As can be seen in FIG. 5, most markers are situated on the 45° axis (similar hybridization strength for treated and untreated samples) after three cycles, and even after 6 cycles there is only a minor shift, but a clear shift is seen after 9 cycles, and confirmed after 10 cycles. Further analysis of the genes that were enriched after heat shock showed that, for the genes in the set with a known function, several known heat stress genes were represented, along with genes related with stress resistance (such as DNA repair genes), indicating the usefulness of the SNP marker identification in such an experimental set up.

TABLE 1
overview of parental specific markers per chromosome, for three spores (B1,
A3 and A4) analyzed after crossing and sporulation of BY4742 and Sigma 1278.

| | B1 | A3 | A4 | | | | |
|---|---|---|---|---|---|---|---|
| Marker_ID | 470 | 466 | 477 | type | qualifier | name | Chr |
| C-01-0029909 | Sigma | BY4742 | BY4742 | | | | |
| D-01-0029950 | Sigma | BY4742 | BY4742 | | | | |
| C-01-0030191 | Sigma | BY4742 | BY4742 | | | | |
| C-01-0030266 | | BY4742 | | | | | |
| C-01-0030352 | Sigma | BY4742 | BY4742 | | | | |
| C-01-0030414 | Sigma | BY4742 | BY4742 | | | | |
| D-01-0030590 | None | BY4742 | BY4742 | | | | |
| C-01-0030833 | None | BY4742 | BY4742 | | | | |
| C-01-0095374 | Sigma | BY4742 | BY4742 | ORF | Verified | SAW1 | 1 |
| C-01-0180101 | None | BY4742 | BY4742 | | | | |
| C-01-0180896 | Sigma | BY4742 | BY4742 | | | | |
| I-01-0198551 | BY4742 | Sigma | BY4742 | | | | |
| I-01-0198555 | BY4742 | Sigma | BY4742 | | | | |
| C-01-0201363 | BY4742 | Sigma | BY4742 | | | | |
| C-01-0202195 | BY4742 | Sigma | BY4742 | | | | |
| C-01-0203579 | Sigma | BY4742 | BY4742 | ORF | Verified | FLO1 | 1 |
| C-01-0223284 | BY4742 | Sigma | BY4742 | | | | |
| C-01-0225248 | BY4742 | Sigma | ??? | | | | |
| C-01-0225315 | BY4742 | Sigma | BY4742 | | | | |
| D-01-0225395 | BY4742 | Sigma | Sigma | | | | |
| C-01-0225423 | BY4742 | Sigma | ??? | | | | |
| C-01-0225609 | BY4742 | Sigma | ??? | ORF | Verified | PHO11 | 1 |
| C-01-0225702 | BY4742 | Sigma | ??? | ORF | Verified | PHO11 | 1 |
| I-02-0023707 | Sigma | BY4742 | BY4742 | | | | |
| I-02-0023707 | Sigma | BY4742 | BY4742 | | | | |
| C-02-0143330 | Sigma | BY4742 | BY4742 | | | | |
| C-02-0146102 | Sigma | BY4742 | BY4742 | | | | |
| I-02-0169905 | Sigma | BY4742 | BY4742 | | | | |
| I-02-0169905 | | BY4742 | BY4742 | | | | |
| C-02-0172325 | Sigma | BY4742 | BY4742 | | | | |
| C-02-0174856 | Sigma | BY4742 | BY4742 | | | | |
| C-02-0191284 | Sigma | BY4742 | BY4742 | ORF | Verified | PEP1 | 2 |
| C-02-0350164 | Sigma | Sigma | BY4742 | | | | |
| C-02-0473072 | Sigma | Sigma | Sigma | ORF | Verified | LYS2 | 2 |
| C-02-0654307 | Sigma | BY4742 | Sigma | ORF | Verified | HPC2 | 2 |
| C-02-0691864 | Sigma | BY4742 | Sigma | | | | |
| C-02-0694119 | Sigma | BY4742 | Sigma | ORF | Verified | PRP5 | 2 |
| C-02-0801701 | BY4742 | None | BY4742 | ORF | Verified | MAL33 | 2 |
| C-02-0801749 | BY4742 | ??? | ??? | ORF | Verified | MAL33 | 2 |
| D-02-0802024 | BY4742 | | BY4742 | | | | |
| C-03-0004351 | BY4742 | BY4742 | Sigma | | | | |
| C-03-0004426 | BY4742 | BY4742 | Sigma | | | | |
| C-03-0005611 | None | None | Sigma | | | | |
| C-03-0006475 | ??? | BY4742 | Sigma | | | | |
| D-04-0144346 | | BY4742 | BY4742 | | | | |
| I-04-0244852 | | BY4742 | | ORF | Verified | UBP1 | 4 |
| D-04-0315178 | BY4742 | BY4742 | Sigma | | | | |
| D-04-0390566 | BY4742 | BY4742 | BY4742 | ORF | Verified | GPR1 | 4 |
| D-04-0434213 | BY4742 | BY4742 | BY4742 | | | | |
| D-04-0435286 | BY4742 | BY4742 | BY4742 | | | | |
| D-04-0491605 | BY4742 | BY4742 | BY4742 | ORF | Verified | RPS11A | 4 |
| I-04-0524750 | BY4742 | BY4742 | BY4742 | | | | |
| C-04-0524887 | BY4742 | BY4742 | BY4742 | | | | |
| C-04-0527077 | BY4742 | BY4742 | BY4742 | ORF | Verified | KRS1 | 4 |
| C-04-0527203 | BY4742 | BY4742 | BY4742 | ORF | Verified | KRS1 | 4 |
| C-04-0527545 | BY4742 | BY4742 | BY4742 | ORF | Verified | ENA5 | 4 |
| C-04-0527740 | BY4742 | BY4742 | BY4742 | ORF | Verified | ENA5 | 4 |
| C-04-0538195 | BY4742 | BY4742 | BY4742 | ORF | Verified | ENA1 | 4 |
| C-04-0541541 | BY4742 | BY4742 | BY4742 | | | | |
| I-04-0694048 | BY4742 | None | Sigma | ORF | Verified | DPB4 | 4 |
| D-04-0721200 | BY4742 | Sigma | Sigma | ORF | Dubious | | 4 |
| C-04-0757561 | BY4742 | BY4742 | Sigma | ORF | Verified | NUM1 | 4 |
| D-04-0851076 | None | BY4742 | Sigma | | | | |
| C-04-0869146 | | BY4742 | | ORF | Verified | MSS4 | 4 |
| D-04-0871813 | None | BY4742 | Sigma | | | | |
| C-04-0927585 | BY4742 | BY4742 | Sigma | ORF | Verified | HEM1 | 4 |
| D-04-0946137 | BY4742 | BY4742 | Sigma | long_terminal_repeat | | | 4 |
| C-04-0957307 | BY4742 | BY4742 | Sigma | ORF | Verified | VHS1 | 4 |
| C-04-1009122 | BY4742 | BY4742 | Sigma | ORF | Verified | GLO2 | 4 |
| C-04-1154573 | BY4742 | BY4742 | BY4742 | ORF | Verified | HXT7 | 4 |
| C-04-1159959 | BY4742 | BY4742 | BY4742 | ORF | Verified | HXT6 | 4 |
| C-04-1160349 | BY4742 | BY4742 | BY4742 | ORF | Verified | HXT6 | 4 |
| C-04-1160412 | BY4742 | BY4742 | BY4742 | ORF | Verified | HXT6 | 4 |
| C-04-1181598 | BY4742 | BY4742 | Sigma | | | | |
| D-04-1175310 | BY4742 | BY4742 | Sigma | long_terminal_repeat | | | 4 |
| I-04-1478574 | BY4742 | BY4742 | Sigma | | | | |
| D-04-1483395 | BY4742 | BY4742 | Sigma | ORF | Dubious | | 4 |
| C-04-1493442 | BY4742 | BY4742 | Sigma | | | | |
| D-04-1503983 | BY4742 | BY4742 | Sigma | ORF | Verified | FIT1 | 4 |
| C-04-1504637 | BY4742 | BY4742 | Sigma | ORF | Verified | FIT1 | 4 |
| D-04-1505682 | BY4742 | BY4742 | Sigma | | | | |
| D-04-1505706 | BY4742 | BY4742 | Sigma | | | | |
| D-04-1518183 | BY4742 | BY4742 | | | | | |
| D-04-1521836 | BY4742 | BY4742 | Sigma | | | | |
| C-05-0015593 | BY4742 | BY4742 | BY4742 | | | | |
| C-05-0018919 | Sigma | Sigma | BY4742 | | | | |
| C-05-0019084 | Sigma | Sigma | BY4742 | | | | |
| C-05-0021226 | Sigma | Sigma | BY4742 | | | | |
| C-05-0069202 | BY4742 | BY4742 | BY4742 | ORF | Dubious | | 5 |
| C-05-0100352 | BY4742 | BY4742 | BY4742 | | | | |
| D-05-0135897 | BY4742 | BY4742 | BY4742 | long_terminal_repeat | | | 5 |
| I-05-0207343 | None | BY4742 | BY4742 | | | | |
| C-05-0243815 | None | Sigma | BY4742 | ORF | Dubious | | 5 |
| C-06-0012663 | BY4742 | ??? | BY4742 | | | | |
| C-06-0013747 | BY4742 | Sigma | BY4742 | ORF | Verified | THI5 | 6 |
| C-06-0013953 | BY4742 | Sigma | BY4742 | | | | |
| C-06-0014404 | BY4742 | Sigma | BY4742 | ORF | Verified | AAD16 | 6 |
| C-06-0014518 | BY4742 | Sigma | BY4742 | ORF | Verified | AAD16 | 6 |
| C-06-0014595 | BY4742 | Sigma | BY4742 | ORF | Verified | AAD16 | 6 |
| C-06-0014740 | BY4742 | Sigma | BY4742 | ORF | Verified | AAD16 | 6 |
| C-06-0014824 | BY4742 | Sigma | BY4742 | ORF | Verified | AAD6 | 6 |
| C-06-0014985 | BY4742 | Sigma | BY4742 | ORF | Verified | AAD6 | 6 |
| C-06-0015225 | BY4742 | Sigma | BY4742 | ORF | Verified | AAD6 | 6 |
| C-06-0015280 | BY4742 | Sigma | BY4742 | ORF | Verified | AAD6 | 6 |
| C-06-0016688 | BY4742 | Sigma | BY4742 | | | | |
| C-06-0016759 | BY4742 | Sigma | BY4742 | | | | |
| D-06-0016777 | BY4742 | Sigma | BY4742 | | | | |
| C-06-0016803 | BY4742 | Sigma | BY4742 | | | | |
| C-06-0018719 | BY4742 | Sigma | BY4742 | | | | |
| C-06-0019952 | BY4742 | Sigma | BY4742 | | | | |
| I-06-0020507 | BY4742 | | | | | | |
| D-06-0022971 | BY4742 | Sigma | BY4742 | | | | |
| I-06-0027552 | BY4742 | Sigma | BY4742 | | | | |
| C-06-0191649 | Sigma | Sigma | Sigma | | | | |
| C-06-0191746 | Sigma | Sigma | Sigma | long_terminal_repeat | | | 6 |
| C-06-0192016 | Sigma | Sigma | Sigma | | | | |
| C-06-0192088 | None | Sigma | Sigma | | | | |
| D-06-0192512 | Sigma | Sigma | Sigma | | | | |
| C-06-0193308 | Sigma | Sigma | Sigma | ORF | Dubious | | 6 |
| C-06-0194061 | Sigma | Sigma | Sigma | | | | |
| C-06-0194166 | Sigma | Sigma | Sigma | | | | |
| C-06-0207667 | Sigma | Sigma | Sigma | ORF | Verified | ECO1 | 6 |
| I-06-0226232 | | | BY4742 | ORF | Dubious | | 6 |
| D-07-0052608 | | Sigma | BY4742 | | | | |
| C-07-0010154 | None | Sigma | BY4742 | | | | |
| C-07-0010469 | None | Sigma | BY4742 | | | | |
| C-07-0010597 | Sigma | Sigma | BY4742 | | | | |
| C-07-0010806 | Sigma | Sigma | BY4742 | | | | |
| C-07-0010967 | None | Sigma | BY4742 | | | | |
| C-07-0011882 | Sigma | Sigma | BY4742 | | | | |
| C-07-0011980 | Sigma | Sigma | BY4742 | | | | |
| C-07-0012062 | Sigma | Sigma | BY4742 | | | | |
| C-07-0012155 | Sigma | Sigma | BY4742 | | | | |
| C-07-0012322 | Sigma | Sigma | BY4742 | | | | |
| C-07-0012436 | Sigma | Sigma | BY4742 | | | | |
| C-07-0012742 | Sigma | Sigma | BY4742 | ORF | Verified | MNT2 | 7 |
| C-07-0017223 | Sigma | Sigma | BY4742 | | | | |
| C-07-0017393 | | | BY4742 | | | | |
| C-07-0017690 | Sigma | Sigma | BY4742 | | | | |
| C-07-0017839 | Sigma | Sigma | BY4742 | | | | |
| C-07-0018251 | Sigma | Sigma | BY4742 | | | | |
| I-07-0018466 | Sigma | Sigma | BY4742 | | | | |
| C-07-0018891 | Sigma | Sigma | BY4742 | | | | |
| C-07-0019168 | Sigma | Sigma | BY4742 | | | | |
| C-07-0021565 | Sigma | Sigma | BY4742 | ORF | Verified | ZRT1 | 7 |
| C-07-0022018 | Sigma | Sigma | BY4742 | ORF | Verified | ZRT1 | 7 |
| C-07-0395794 | Sigma | Sigma | Sigma | ORF | Uncharacterized | GEP7 | 7 |
| I-07-0544719 | | | Sigma | | | | |
| D-07-0546403 | None | None | Sigma | | | | |
| C-07-0594399 | Sigma | Sigma | Sigma | ORF | Uncharacterized | FMP48 | 7 |
| I-07-0779119 | BY4742 | None | Sigma | | | | |
| C-07-0808054 | BY4742 | Sigma | BY4742 | | | | |
| C-07-0823438 | BY4742 | Sigma | BY4742 | | | | |
| C-07-0882569 | Sigma | Sigma | BY4742 | | | | |
| I-08-0049393 | Sigma | BY4742 | BY4742 | ORF | Verified | WSC4 | 8 |
| C-08-0074608 | BY4742 | Sigma | Sigma | | | | |
| C-08-0074711 | BY4742 | Sigma | Sigma | | | | |
| D-08-0085381 | BY4742 | | Sigma | ORF | Uncharacterized | | 8 |
| D-08-0085385 | BY4742 | None | Sigma | | | | |
| D-08-0086049 | BY4742 | ??? | ??? | long_terminal_repeat | | | 8 |
| D-08-0086166 | BY4742 | ??? | ??? | retrotransposon | | | 8 |
| D-08-0086166 | BY4742 | Sigma | Sigma | retrotransposon | | | 8 |
| D-08-0086178 | BY4742 | | | retrotransposon | | | 8 |
| D-08-0086190 | BY4742 | ??? | ??? | retrotransposon | | | 8 |
| D-08-0088776 | BY4742 | ??? | ??? | retrotransposon | | | 8 |
| D-08-0088891 | BY4742 | BY4742 | BY4742 | retrotransposon | | | 8 |
| D-08-0091008 | BY4742 | ??? | ??? | retrotransposon | | | 8 |
| D-08-0091067 | BY4742 | ??? | ??? | retrotransposon | | | 8 |
| D-08-0091339 | BY4742 | Sigma | Sigma | retrotransposon | | | 8 |
| D-08-0091525 | BY4742 | Sigma | Sigma | retrotransposon | | | 8 |
| D-08-0091775 | BY4742 | Sigma | Sigma | retrotransposon | | | 8 |
| D-08-0092034 | BY4742 | Sigma | Sigma | long_terminal_repeat | | | 8 |
| C-08-0092451 | BY4742 | | Sigma | long_terminal_repeat | | | 8 |
| C-08-0094511 | BY4742 | Sigma | Sigma | | | | |
| C-08-0094744 | BY4742 | Sigma | Sigma | | | | |
| I-08-0094747 | BY4742 | Sigma | Sigma | | | | |
| I-08-0094750 | BY4742 | Sigma | Sigma | | | | |
| I-08-0094759 | BY4742 | Sigma | Sigma | | | | |
| I-08-0094762 | BY4742 | Sigma | Sigma | | | | |
| I-08-0094765 | BY4742 | Sigma | Sigma | | | | |
| I-08-0094766 | BY4742 | Sigma | Sigma | | | | |
| I-08-0094769 | BY4742 | Sigma | Sigma | | | | |
| I-08-0094770 | BY4742 | Sigma | Sigma | | | | |
| I-08-0094777 | BY4742 | Sigma | Sigma | | | | |
| I-08-0094834 | BY4742 | Sigma | Sigma | | | | |
| I-08-0094843 | BY4742 | Sigma | Sigma | | | | |
| I-08-0094843 | BY4742 | | Sigma | | | | |
| I-08-0094851 | BY4742 | Sigma | Sigma | | | | |
| C-08-0094883 | BY4742 | Sigma | Sigma | | | | |
| I-08-0094891 | BY4742 | Sigma | Sigma | | | | |
| I-08-0094907 | BY4742 | None | Sigma | | | | |
| D-08-0116420 | BY4742 | Sigma | Sigma | | | | |
| I-08-0119670 | BY4742 | Sigma | Sigma | | | | |
| D-08-0123640 | BY4742 | Sigma | Sigma | long_terminal_repeat | | | 8 |
| I-08-0133121 | BY4742 | Sigma | Sigma | | | | |
| I-08-0133340 | BY4742 | None | Sigma | long_terminal_repeat | | | 8 |
| C-08-0150072 | | | Sigma | | | | |
| D-08-0184012 | Sigma | BY4742 | Sigma | ORF | Uncharacterized | | 8 |
| C-08-0219928 | | | BY4742 | | | | |
| I-08-0551325 | BY4742 | | | ORF | Uncharacterized | | 8 |
| I-08-0551328 | BY4742 | Sigma | ??? | ORF | Uncharacterized | | 8 |
| I-08-0551332 | BY4742 | Sigma | Sigma | ORF | Uncharacterized | | 8 |
| I-08-0551332 | BY4742 | Sigma | Sigma | ORF | Uncharacterized | | 8 |
| I-08-0551337 | BY4742 | Sigma | ??? | ORF | Uncharacterized | | 8 |
| I-08-0551343 | BY4742 | Sigma | ??? | ORF | Uncharacterized | | 8 |
| I-08-0551352 | BY4742 | Sigma | Sigma | ORF | Uncharacterized | | 8 |
| I-08-0551355 | BY4742 | Sigma | Sigma | ORF | Uncharacterized | | 8 |
| I-08-0551360 | BY4742 | Sigma | Sigma | ORF | Uncharacterized | | 8 |
| I-08-0551364 | BY4742 | Sigma | Sigma | ORF | Uncharacterized | | 8 |
| I-08-0551368 | BY4742 | Sigma | Sigma | ORF | Uncharacterized | | 8 |
| I-08-0551372 | BY4742 | Sigma | Sigma | ORF | Uncharacterized | | 8 |
| I-08-0551379 | BY4742 | Sigma | Sigma | ORF | Uncharacterized | | 8 |
| I-08-0551382 | BY4742 | Sigma | ??? | ORF | Uncharacterized | | 8 |
| I-08-0551388 | BY4742 | Sigma | ??? | ORF | Uncharacterized | | 8 |
| I-08-0551390 | BY4742 | Sigma | Sigma | ORF | Uncharacterized | | 8 |
| I-08-0551394 | BY4742 | Sigma | ??? | ORF | Uncharacterized | | 8 |
| I-08-0551399 | BY4742 | Sigma | BY4742 | ORF | Uncharacterized | | 8 |
| I-08-0551404 | BY4742 | Sigma | ??? | ORF | Uncharacterized | | 8 |
| C-08-0551409 | BY4742 | Sigma | BY4742 | ORF | Uncharacterized | | 8 |
| I-08-0551414 | BY4742 | Sigma | ??? | ORF | Uncharacterized | | 8 |
| I-08-0551425 | BY4742 | Sigma | BY4742 | ORF | Uncharacterized | | 8 |
| C-08-0551539 | BY4742 | Sigma | BY4742 | | | | |
| C-08-0551763 | BY4742 | Sigma | Sigma | | | | |
| C-08-0551843 | BY4742 | | Sigma | | | | |
| C-08-0551877 | BY4742 | Sigma | Sigma | | | | |
| C-08-0552350 | BY4742 | Sigma | Sigma | ORF | Verified | PHO12 | 8 |
| C-08-0552451 | BY4742 | Sigma | Sigma | ORF | Verified | PHO12 | 8 |
| C-08-0552599 | BY4742 | Sigma | BY4742 | ORF | Verified | PHO12 | 8 |
| C-08-0552666 | BY4742 | Sigma | BY4742 | ORF | Verified | PHO12 | 8 |
| C-08-0552992 | BY4742 | Sigma | BY4742 | ORF | Verified | PHO12 | 8 |
| C-08-0553115 | BY4742 | Sigma | BY4742 | ORF | Verified | PHO12 | 8 |
| C-09-0033191 | BY4742 | Sigma | BY4742 | | | | |
| C-09-0033327 | BY4742 | Sigma | BY4742 | | | | |
| C-09-0033412 | BY4742 | Sigma | BY4742 | | | | |
| C-09-0035894 | BY4742 | Sigma | BY4742 | | | | |
| C-09-0083061 | BY4742 | BY4742 | BY4742 | | | | |
| D-09-0137689 | None | BY4742 | BY4742 | ORF | Verified | RPI1 | 9 |
| C-09-0139439 | Sigma | BY4742 | BY4742 | | | | |
| D-09-0196651 | Sigma | Sigma | BY4742 | long_terminal_repeat | | | 9 |
| I-09-0293871 | None | Sigma | BY4742 | ORF | Verified | ULP2 | 9 |
| C-09-0318366 | Sigma | Sigma | Sigma | ORF | Verified | VID28 | 9 |
| I-09-0324690 | None | Sigma | Sigma | long_terminal_repeat | | | 9 |
| I-09-0334383 | Sigma | Sigma | Sigma | ORF | Verified | TIR3 | 9 |
| D-09-0368475 | Sigma | Sigma | Sigma | ORF | Verified | PAN1 | 9 |
| C-09-0382328 | Sigma | Sigma | Sigma | ORF | Verified | RPR2 | 9 |
| D-09-0385528 | Sigma | Sigma | Sigma | | | | |
| D-09-0385920 | Sigma | Sigma | Sigma | | | | |
| C-09-0386241 | Sigma | Sigma | Sigma | | | | |
| C-09-0386545 | Sigma | Sigma | Sigma | | | | |
| I-09-0393333 | Sigma | Sigma | Sigma | ORF | Verified | MUC1 | 9 |
| I-09-0393336 | Sigma | Sigma | Sigma | ORF | Verified | MUC1 | 9 |
| I-09-0394843 | Sigma | Sigma | Sigma | | | | |
| I-09-0425278 | Sigma | Sigma | BY4742 | | | | |
| I-09-0425281 | Sigma | Sigma | BY4742 | | | | |
| C-10-0024377 | BY4742 | Sigma | BY4742 | ORF | Uncharacterized | | 10 |
| C-10-0024438 | BY4742 | | BY4742 | ORF | Uncharacterized | | 10 |
| C-10-0024710 | BY4742 | Sigma | BY4742 | ORF | Uncharacterized | | 10 |
| C-10-0024857 | BY4742 | Sigma | BY4742 | ORF | Uncharacterized | | 10 |
| C-10-0025127 | BY4742 | Sigma | BY4742 | ORF | Uncharacterized | | 10 |
| C-10-0025298 | BY4742 | Sigma | BY4742 | ORF | Uncharacterized | | 10 |
| D-10-0028304 | BY4742 | Sigma | BY4742 | ORF | Verified | HXT8 | 10 |
| C-10-0030656 | BY4742 | Sigma | BY4742 | | | | |
| C-10-0031756 | BY4742 | Sigma | BY4742 | | | | |
| C-10-0079583 | BY4742 | BY4742 | Sigma | | | | |
| C-10-0081739 | BY4742 | BY4742 | Sigma | ORF | Verified | MNN5 | 10 |
| D-10-0114930 | | BY4742 | | ORF | Verified | JJJ2 | 10 |
| C-10-0116400 | BY4742 | BY4742 | Sigma | | | | |
| I-10-0120864 | BY4742 | None | Sigma | ORF | Verified | HSP150 | 10 |
| D-10-0120977 | None | BY4742 | None | ORF | Verified | HSP150 | 10 |
| C-10-0159099 | BY4742 | BY4742 | Sigma | ORF | Verified | LCB3 | 10 |
| C-10-0204328 | BY4742 | BY4742 | Sigma | | | | |
| D-10-0285366 | Sigma | BY4742 | Sigma | | | | |
| I-10-0293089 | Sigma | BY4742 | Sigma | ORF | Verified | PRY3 | 10 |
| I-10-0293095 | Sigma | BY4742 | Sigma | ORF | Verified | PRY3 | 10 |
| C-10-0293470 | Sigma | BY4742 | Sigma | ORF | Verified | PRY3 | 10 |
| I-10-0293479 | Sigma | BY4742 | Sigma | ORF | Verified | PRY3 | 10 |
| C-10-0294468 | Sigma | BY4742 | Sigma | | | | |
| C-10-0307282 | None | BY4742 | Sigma | ORF | Verified | ARG2 | 10 |
| D-10-0314903 | Sigma | BY4742 | Sigma | | | | |
| D-10-0332670 | | BY4742 | Sigma | ORF | Verified | ZAP1 | 10 |
| C-10-0518435 | Sigma | Sigma | BY4742 | | | | |
| D-10-0543599 | None | Sigma | BY4742 | long_terminal_repeat | | | 10 |
| D-10-0543942 | Sigma | Sigma | BY4742 | | | | |
| C-11-0002625 | Sigma | BY4742 | | ORF | Dubious | | 11 |
| I-11-0144921 | Sigma | BY4742 | BY4742 | ORF | Verified | PIR3 | 11 |
| I-11-0144924 | Sigma | BY4742 | BY4742 | ORF | Verified | PIR3 | 11 |
| C-11-0146588 | Sigma | BY4742 | BY4742 | | | | |
| C-11-0146920 | Sigma | BY4742 | BY4742 | | | | |
| C-11-0257637 | | BY4742 | | | | | |
| I-11-0273430 | Sigma | BY4742 | BY4742 | ORF | Verified | MIF2 | 11 |
| C-11-0354718 | Sigma | BY4742 | BY4742 | ORF | Verified | PRI2 | 11 |
| C-11-0354239 | Sigma | BY4742 | BY4742 | | | | |
| C-11-0378542 | BY4742 | | | | | | |
| I-11-0388788 | BY4742 | BY4742 | BY4742 | | | | |
| C-11-0391592 | BY4742 | BY4742 | BY4742 | ORF | Verified | PAN3 | 11 |
| C-11-0489954 | BY4742 | BY4742 | BY4742 | long_terminal_repeat | | | 11 |
| C-11-0505135 | BY4742 | BY4742 | BY4742 | ORF | Verified | SPO14 | 11 |
| C-11-0570558 | BY4742 | BY4742 | Sigma | | | | |
| C-11-0606526 | BY4742 | BY4742 | Sigma | ORF | Verified | TGL4 | 11 |
| D-11-0612771 | BY4742 | BY4742 | Sigma | ORF | Verified | SRP40 | 11 |
| C-11-0615812 | BY4742 | BY4742 | Sigma | ORF | Verified | PTR2 | 11 |
| D-11-0643512 | BY4742 | BY4742 | Sigma | | | | |
| C-11-0647409 | BY4742 | BY4742 | Sigma | ORF | Verified | FLO10 | 11 |
| C-12-0031811 | BY4742 | None | Sigma | | | | |
| C-12-0035189 | BY4742 | Sigma | Sigma | ORF | Uncharacterized | | 12 |
| I-12-0036047 | BY4742 | Sigma | Sigma | ORF | Verified | AQY2 | 12 |
| D-12-0037192 | BY4742 | Sigma | Sigma | | | | |
| I-12-0130131 | BY4742 | | | ORF | Verified | PSR1 | 12 |
| I-12-0130659 | BY4742 | Sigma | Sigma | | | | |
| I-12-0130659 | | | Sigma | | | | |
| D-12-0252863 | Sigma | BY4742 | Sigma | ORF | Verified | SPT8 | 12 |
| D-12-0350814 | Sigma | Sigma | BY4742 | ORF | Verified | MDN1 | 12 |
| I-12-0366141 | Sigma | Sigma | BY4742 | long_terminal_repeat | | | 12 |
| C-12-0373095 | Sigma | Sigma | BY4742 | | | | |
| I-12-0373672 | Sigma | Sigma | BY4742 | | | | |
| D-12-0374000 | None | Sigma | BY4742 | long_terminal_repeat | | | 12 |
| I-12-0458688 | None | BY4742 | BY4742 | rRNA | | NTS2-1 | 12 |
| C-12-0491054 | Sigma | BY4742 | BY4742 | | | | |
| C-12-0707304 | Sigma | Sigma | BY4742 | | | | |
| I-12-0770987 | BY4742 | Sigma | Sigma | ORF | Verified | BUD6 | 12 |
| C-12-0776349 | BY4742 | Sigma | BY4742 | | | | |
| C-12-0789259 | BY4742 | Sigma | Sigma | ORF | Verified | CHS5 | 12 |
| I-12-0789272 | BY4742 | Sigma | Sigma | ORF | Verified | CHS5 | 12 |
| C-12-0803754 | BY4742 | Sigma | Sigma | ORF | Verified | VRP1 | 12 |
| C-12-0806918 | BY4742 | Sigma | Sigma | | | | |
| C-12-0810884 | BY4742 | Sigma | Sigma | ORF | Verified | FKS1 | 12 |
| C-12-0811640 | BY4742 | Sigma | Sigma | ORF | Verified | FKS1 | 12 |
| C-12-0815475 | BY4742 | Sigma | BY4742 | ORF | Verified | FKS1 | 12 |
| C-12-0815890 | BY4742 | Sigma | BY4742 | ORF | Uncharacterized | | 12 |
| C-12-0817850 | BY4742 | Sigma | BY4742 | | | | |
| C-12-0818534 | BY4742 | Sigma | BY4742 | | | | |
| C-12-0818791 | BY4742 | Sigma | BY4742 | | | | |
| C-12-0823313 | BY4742 | Sigma | BY4742 | | | | |
| D-12-0877702 | BY4742 | Sigma | BY4742 | | | | |
| C-12-0877965 | BY4742 | Sigma | BY4742 | | | | |
| C-12-0929931 | BY4742 | Sigma | BY4742 | ORF | Verified | DUS4 | 12 |
| C-12-0932243 | BY4742 | Sigma | BY4742 | ORF | Uncharacterized | | 12 |
| D-12-0932271 | BY4742 | | | ORF | Uncharacterized | | 12 |
| D-12-0932281 | BY4742 | Sigma | BY4742 | ORF | Uncharacterized | | 12 |
| C-13-0121935 | BY4742 | BY4742 | Sigma | | | | |
| I-13-0122782 | BY4742 | BY4742 | Sigma | | | | |
| D-13-0122963 | BY4742 | BY4742 | Sigma | | | | |
| C-13-0123828 | BY4742 | BY4742 | Sigma | ORF | Verified | RPL6A | 13 |
| C-13-0124027 | BY4742 | BY4742 | Sigma | ORF | Verified | RPL6A | 13 |
| D-13-0132701 | Sigma | BY4742 | Sigma | | | | |
| C-13-0132728 | Sigma | BY4742 | Sigma | | | | |
| C-13-0158997 | Sigma | BY4742 | Sigma | | | | |
| D-13-0305342 | Sigma | Sigma | Sigma | ORF | Verified | SOK2 | 13 |
| C-13-0324004 | Sigma | Sigma | Sigma | ORF | Verified | CSI1 | 13 |
| C-13-0371523 | Sigma | Sigma | BY4742 | | | | |
| C-13-0371650 | None | Sigma | BY4742 | | | | |
| C-13-0371908 | Sigma | Sigma | BY4742 | | | | |
| D-13-0372571 | None | None | BY4742 | | | | |
| I-13-0420971 | Sigma | Sigma | BY4742 | | | | |
| I-13-0420974 | Sigma | Sigma | BY4742 | | | | |
| I-13-0420979 | Sigma | Sigma | BY4742 | | | | |
| C-13-0448687 | BY4742 | Sigma | BY4742 | | | | |
| C-13-0448754 | BY4742 | Sigma | BY4742 | | | | |
| C-13-0528894 | BY4742 | Sigma | BY4742 | ORF | Verified | POM152 | 13 |
| C-13-0599885 | BY4742 | Sigma | Sigma | ORF | Verified | ALD3 | 13 |
| I-13-0608936 | BY4742 | Sigma | None | ORF | Verified | DDR48 | 13 |
| C-13-0828273 | BY4742 | Sigma | BY4742 | ORF | Verified | CAT8 | 13 |
| D-13-0828324 | BY4742 | Sigma | BY4742 | ORF | Verified | CAT8 | 13 |
| I-13-0837916 | BY4742 | Sigma | BY4742 | | | | |
| C-14-0009594 | BY4742 | ??? | BY4742 | | | | |
| C-14-0010660 | BY4742 | BY4742 | BY4742 | | | | |
| C-14-0010968 | BY4742 | BY4742 | BY4742 | | | | |
| C-14-0087310 | Sigma | BY4742 | Sigma | | | | |
| C-14-0119359 | Sigma | BY4742 | Sigma | ORF | Verified | BOR1 | 14 |
| C-14-0119667 | None | BY4742 | Sigma | ORF | Verified | BOR1 | 14 |
| C-14-0119921 | Sigma | BY4742 | Sigma | ORF | Verified | BOR1 | 14 |
| C-14-0206893 | Sigma | Sigma | BY4742 | | | | |
| D-14-0290021 | Sigma | Sigma | BY4742 | ORF | Verified | UBP10 | 14 |
| D-14-0290057 | Sigma | Sigma | BY4742 | ORF | Verified | UBP10 | 14 |
| I-14-0552433 | Sigma | Sigma | BY4742 | | | | |
| C-14-0736287 | Sigma | Sigma | BY4742 | | | | |
| C-14-0738533 | Sigma | Sigma | BY4742 | ORF | Verified | MNT4 | 14 |
| C-14-0743855 | Sigma | Sigma | BY4742 | | | | |
| C-14-0744001 | Sigma | Sigma | BY4742 | | | | |
| C-14-0744086 | Sigma | Sigma | BY4742 | | | | |
| C-14-0745414 | Sigma | Sigma | BY4742 | | | | |
| C-14-0750684 | BY4742 | Sigma | BY4742 | ORF | Uncharacterized | | 14 |
| C-14-0753372 | Sigma | Sigma | BY4742 | ORF | Uncharacterized | | 14 |
| C-15-0023718 | BY4742 | None | BY4742 | ORF | Uncharacterized | | 15 |
| C-15-0024858 | BY4742 | None | None | | | | |
| I-15-0029318 | BY4742 | Sigma | BY4742 | ORF | Verified | HPF1 | 15 |
| D-15-0216614 | BY4742 | BY4742 | BY4742 | | | | |
| C-15-0306069 | BY4742 | BY4742 | BY4742 | ORF | Verified | PLB3 | 15 |
| D-15-0307257 | BY4742 | BY4742 | BY4742 | ORF | Verified | PLB3 | 15 |
| D-15-0316435 | BY4742 | BY4742 | BY4742 | | | | |
| D-15-0316438 | BY4742 | BY4742 | BY4742 | | | | |
| C-15-0384665 | BY4742 | BY4742 | BY4742 | ORF | Dubious | | 15 |
| C-15-0385035 | BY4742 | BY4742 | BY4742 | | | | |
| C-15-0385488 | BY4742 | BY4742 | BY4742 | | | | |
| C-15-0389604 | BY4742 | BY4742 | BY4742 | | | | |
| C-15-0419348 | BY4742 | BY4742 | BY4742 | ORF | Verified | RAT1 | 15 |
| D-15-0506075 | Sigma | Sigma | BY4742 | ORF | Verified | RPS7A | 15 |
| C-15-0515074 | Sigma | Sigma | BY4742 | | | | |
| C-15-0515706 | Sigma | Sigma | BY4742 | ORF | Verified | RAS1 | 15 |
| C-15-0515919 | Sigma | Sigma | BY4742 | ORF | Verified | RAS1 | 15 |
| C-15-0516056 | Sigma | Sigma | BY4742 | ORF | Verified | RAS1 | 15 |
| C-15-0517061 | Sigma | Sigma | BY4742 | | | | |
| C-15-0517615 | None | Sigma | BY4742 | | | | |
| C-15-0518744 | Sigma | Sigma | BY4742 | | | | |
| D-15-0534521 | Sigma | None | None | ORF | Verified | AZF1 | 15 |
| C-15-0592963 | BY4742 | Sigma | BY4742 | | | | |
| C-15-0606368 | BY4742 | Sigma | BY4742 | | | | |
| I-15-0859598 | Sigma | Sigma | BY4742 | ORF | Verified | SNF2 | 15 |
| C-15-0969852 | Sigma | None | None | | | | |
| C-15-0976525 | Sigma | Sigma | BY4742 | | | | |
| I-15-0979755 | Sigma | Sigma | BY4742 | | | | |
| I-15-1019101 | Sigma | Sigma | BY4742 | | | | |
| D-15-1073326 | Sigma | Sigma | Sigma | | | | |
| C-15-1073358 | Sigma | Sigma | Sigma | | | | |
| C-15-1075083 | None | Sigma | Sigma | ORF | Uncharacterized | | 15 |
| C-15-1076092 | None | Sigma | Sigma | | | | |
| C-16-0016732 | Sigma | Sigma | Sigma | ORF | Uncharacterized | | 16 |
| C-16-0020127 | Sigma | Sigma | Sigma | | | | |
| I-16-0020167 | Sigma | Sigma | Sigma | | | | |
| C-16-0020538 | Sigma | Sigma | Sigma | | | | |
| C-16-0020903 | Sigma | Sigma | Sigma | | | | |
| C-16-0021082 | Sigma | Sigma | Sigma | | | | |
| C-16-0024044 | Sigma | Sigma | Sigma | ORF | Verified | SAM3 | 16 |
| C-16-0024844 | Sigma | Sigma | Sigma | | | | |
| I-16-0056110 | Sigma | Sigma | Sigma | | | | |
| I-16-0064393 | Sigma | Sigma | Sigma | | | | |
| C-16-0668434 | Sigma | BY4742 | Sigma | ORF | Verified | SEC8 | 16 |
| C-16-0688626 | None | BY4742 | Sigma | ORF | Uncharacterized | | 16 |
| I-16-0688943 | Sigma | BY4742 | Sigma | | | | |
| C-16-0776868 | Sigma | BY4742 | Sigma | | | | |
| I-16-0786299 | Sigma | BY4742 | Sigma | ORF | Verified | CTR1 | 16 |
| I-16-0786440 | Sigma | BY4742 | Sigma | ORF | Verified | CTR1 | 16 |
| I-16-0814893 | BY4742 | BY4742 | Sigma | ORF | Verified | TAZ1 | 16 |
| I-16-0818531 | BY4742 | BY4742 | Sigma | ORF | Verified | RRP15 | 16 |
| I-16-0819449 | BY4742 | BY4742 | Sigma | | | | |
| D-16-0850629 | BY4742 | BY4742 | Sigma | long_terminal_repeat | | | 16 |
| C-16-0923644 | BY4742 | BY4742 | Sigma | | | | |
| D-16-0927316 | BY4742 | BY4742 | Sigma | | | | |
| C-16-0929547 | BY4742 | BY4742 | Sigma | | | | |
| C-16-0929740 | BY4742 | BY4742 | Sigma | | | | |

The marker identity indicates whether the mutation is a SNP cluster (C), a deletion (D) or an insertion (I). The first number indicates the chromosome, the second one the start position on the chromosome

### REFERENCES

Gresham, D., Ruderfer, D. M., Pratt, S. C., Schacherer J., Dunham, M. J., Botstein, D and Kruglyak, L. (2006) Genome wide detection of polymorphisms at nucleotide resolution with single DNA microarray. Science, 311, 1932-1936.
Liti, G., Carter, D. M., Moses, A. M., Warringer, J., Parts, L., James, S. A., Davey, R. P., Roberts, I. N., Burt, A., Koufopanou, V., Tsai, I. J., Bergman, C. M., Bensasson, D., O'Kelly, M. J. T., van Oudernaarden, A., Barton, D. B. H., Bailes, E., Nguyen Ba, A. N., Jones, M., Quail, M. A., Goodhead I., Sims, S., Smith, F., Blomberg, A., Durbin, R and Louis, E. J. (2009) Nature, 458, 337-341.
Schacherer J., Ruderfer, D. M., Gresham, D., Dolinski, K., Botstein, D., and Kruglyak, L. (2007) Genome-wide analysis of nucleotide-level variation in commonly used Saccharomyces cerevisiae strains. Plos one, 3, e322.
Schacherer, J., Shapiro, J. A., Ruderfer, D. M. and Kruglyak, L. (2009). Comprehensive polymorphism survey elucidates population structure of Saccharomyces cerevisiae. Nature, 458, 342-346.
Tian, D., Wang, Q., Zhan, P., Araki, H., Yang, S., Kreitman, M., Nagylaki, T., Hudson, R., Bergelson, J. and Chen, J. Q. (2008). Single nucleotide mutation rate increase close to insertion/deletions in eukaryotes. Nature, 455, 105-108.

1. A method for detecting at least one target sequence comprising a cluster of at least two single nucleotide polymorphisms, said method comprising:
hybridizing a target sequence against an array of at least two oligonucleotides,
wherein said oligonucleotides consist of a variation in sequence of the complement of the target sequence with a different hybridization efficiency.

2. The method according to claim 1, wherein said variation in sequence is realized by varying the length of the 5′ and 3′ sequences, adjacent to said cluster without changing the oligonucleotide's total length, or with only a limited change in length.

3. The method according to claim 1, wherein said variation in sequence is realized by combining matches and mismatches upstream and downstream of the single nucleotide polymorphisms of said cluster.

4. The method according to claim 1, further comprising utilizing the method for strain identification.

5. The method according to claim 1, further comprising utilizing the method for the identification of genetic markers linked to a phenotype.

6. The method according to claim 1, further comprising utilizing the method for marker identification and/or detection, useful in strain breeding.

7. The use of a method according to claim 5, wherein said method is carried out on nucleic acid isolated from a mixed population.

8. The method according to claim 4, wherein said strain is a yeast strain.

9. A method for strain identification by detecting at least one target sequence comprising a cluster of at least two single nucleotide polymorphisms, the method comprising:
hybridizing a target sequence against an array of at least two oligonucleotides,
wherein the at least two oligonucleotides have a variation in sequence of the target sequence's complement with a different hybridization efficiency.

10. The method according to claim 9, wherein the variation in sequence comprises varying the length of the 5′ and 3′ sequences, adjacent to the cluster without changing the oligonucleotide's total length.

11. The method according to claim 9, wherein the variation in sequence comprises varying the length of the 5′ and 3′ sequences, adjacent to the cluster with a limited change in the oligonucleotide's total length.

12. The method according to claim 9, wherein the variation in sequence comprises combining matches and mismatches upstream and downstream of the cluster's single nucleotide polymorphisms.

13. A method for identifying a genetic marker linked to a phenotype by detecting at least one target sequence therein comprising a cluster of at least two single nucleotide polymorphisms, the method comprising:
hybridizing a target sequence against an array of at least two oligonucleotides,
wherein the at least two oligonucleotides have a variation in sequence of the target sequence's complement sequence with a different hybridization efficiency.

14. The method according to claim 13, wherein the variation in sequence comprises varying the length of the 5′ and 3′ sequences, adjacent to the cluster without changing the oligonucleotide's total length.

15. The method according to claim 13, wherein the variation in sequence comprises varying the length of the 5′ and 3′ sequences, adjacent to the cluster with a limited change in the oligonucleotide's total length.

16. The method according to claim 13, wherein the variation in sequence comprises combining matches and mismatches upstream and downstream of the cluster's single nucleotide polymorphisms.

17. The method according to claim 13, wherein the target sequence comprises nucleic acid isolated from a mixed population.

18. A method for marker identification and/or detection by detecting at least one target sequence comprising a cluster of at least two single nucleotide polymorphisms, the method comprising:
hybridizing a target sequence against an array of at least two oligonucleotides,
wherein the at least two oligonucleotides have a variation in sequence of the target sequence's complement with a different hybridization efficiency.

19. The method according to claim 18, wherein the target sequence comprises nucleic acid isolated from a mixed population.

20. The method according to claim 6, wherein the strain is a yeast strain.
